(19) United States
(12) Patent Application Publication
(10) Pub. No.: US 2025/0311756 A1
(43) Pub. Date: Oct. 9, 2025

(54) AGENT FOR REDUCING CONTAMINATION IN FRYING OIL

(71) Applicant: J-OIL MILLS, INC., Tokyo (JP)

(72) Inventors: Tomoki HORIGANE, Tokyo (JP); Kenta KATOU, Tokyo (JP)

(21) Appl. No.: 18/865,853

(22) PCT Filed: May 15, 2023
(86) PCT No.: PCT/JP2023/018051

§ 371 Date: Nov. 14, 2024

(30) Foreign Application Priority Data
May 31, 2022 (JP) 2022-088469

(51) Int. Cl. A23L 7/157; A23L 5/10; A23L 29/212

(52) U.S. Cl. CPC A23L 7/157; A23L 29/212; A23L 5/11

(57) ABSTRACT

Provided is an agent for reducing contamination in frying oil containing the following ingredient (A). Ingredient (A): a powdery granular material satisfying a condition (1) of having a starch content of 75% by mass or more, a condition (2) of containing 3% by mass or more and 45% by mass or less of a low-molecular-weight starch that is a starch having an amylose content of 5% by mass or more, in which a peak molecular weight of the low-molecular-weight starch is 3×103 or more and 5×104 or less, a condition (3) of having a degree of swelling in cold water at 25° C. of 5 or more and 20 or less, and a condition (4) of having a content of a fraction passing through a sieve with an opening of 1.4 mm and on a sieve with an opening of 0.15 mm of 5% by mass or more and 100% by mass or less.

### TECHNICAL FIELD

The present invention relates to an agent for reducing contamination in frying oil.

### BACKGROUND ART

As a technique for reducing contamination in frying oil, there is a technique disclosed in Patent Document 1 (Japanese Unexamined Patent Publication No. 2012-95595). In the document, it is described that a sprinkle-type mix powder for Karaage, containing 20 parts by mass or more and 50 parts by mass or less of α-starch, 20 parts by mass or more and 50 parts by mass or less of corn grits, and 5 parts by mass or more and 20 parts by mass or less of fine bread crumbs (claim 1). According to the document, by using the sprinkle-type mix powder for Karaage disclosed in the document, a fried product with a good texture can be obtained, and contaminants in the frying oil can be reduced, resulting in a high product yield (paragraph 0006).

### RELATED DOCUMENT

### Patent Document

[Patent Document 1] Japanese Unexamined Patent Publication No. 2012-95595

### SUMMARY OF THE INVENTION

### Technical Problem

As a result of studies by the present inventors on the technique disclosed in Patent Document 1, it has been newly found that, for example, in the manufacture of a food containing a spice, there is still room for further improvement in reducing the contamination in the frying oil.

The present invention is to provide a new technique for reducing the contamination in the frying oil.

### Solution to Problem

According to the present invention, the following agent for reducing contamination in frying oil and method for reducing contamination in frying oil are provided.
[1] An agent for reducing contamination in frying oil containing the following ingredient (A),

ingredient (A): a powdery granular material satisfying the following conditions (1) to (4),
(1) having a starch content of 75% by mass or more,
(2) containing 3% by mass or more and 45% by mass or less of a low-molecular-weight starch that is a starch having an amylose content of 5% by mass or more, in which a peak molecular weight of the low-molecular-weight starch is 3×10³ or more and 5×10⁴ or less,
(3) having a degree of swelling in cold water at 25° C. of 5 or more and 20 or less, and
(4) having a content of a fraction passing through a sieve with an opening of 1.4 mm and on a sieve with an opening of 0.15 mm of 5% by mass or more and 100% by mass or less.
[2] The agent for reducing contamination in frying oil according to [1], being applied to a fried food containing a spice.
[3] The agent for reducing contamination in frying oil according to [2], in which the spice contains capsaicin.
[4] The agent for reducing contamination in frying oil according to any one of [1] to [3], being applied to a fried food, in which the fried food is one kind selected from the group consisting of Karaage, fried chicken, Tatsutaage, Tempura, and nugget.
[5] The agent for reducing contamination in frying oil according to any one of [1] to [4], being applied to a fried food and blended in a coating material of the fried food.
[6] The agent for reducing contamination in frying oil according to [5], in which the coating material is a batter liquid.
[7] A method for reducing contamination in frying oil, including:

incorporating the following ingredient (A) into a fried food,

the ingredient (A): a powdery granular material satisfying the following conditions (1) to (4),
(1) having a starch content of 75% by mass or more,
(2) containing 3% by mass or more and 45% by mass or less of a low-molecular-weight starch that is a starch having an amylose content of 5% by mass or more, in which a peak molecular weight of the low-molecular-weight starch is 3×10³ or more and 5×10⁴ or less,
(3) having a degree of swelling in cold water at 25° C. of 5 or more and 20 or less, and
(4) having a content of a fraction passing through a sieve with an opening of 1.4 mm and on a sieve with an opening of 0.15 mm of 5% by mass or more and 100% by mass or less.
[8] The method for reducing contamination in frying oil according to [7], in which the fried food contains a spice.
[9] The method for reducing contamination in frying oil according to [8], in which the spice contains capsaicin.
[10] The method for reducing contamination in frying oil according to any one of [7] to [9], in which the fried food is one kind selected from the group consisting of Karaage, fried chicken, Tatsutaage, Tempura, and nugget.
[11] The method for reducing contamination in frying oil according to any one of [7] to [10], in which the ingredient (A) is blended in a coating material of the fried food.
[12] The method for reducing contamination in frying oil according to [11], in which the coating material is a batter liquid.

Any combination of each of these configurations or any aspect in which the expression of the present invention is converted between method, apparatus, and the like is also valid as an aspect of the present invention.

For example, according to the present invention, it is also possible to provide a fried food containing the agent for reducing contamination in frying oil according to the present invention and a spice.

### Advantageous Effects of Invention

As described above, according to the present invention, it is possible to provide a new technique for reducing the contamination in the frying oil.

### DESCRIPTION OF EMBODIMENTS

Hereinafter, embodiments of the present invention will be described with specific examples of each component. As each component, one substance can be used alone or two or more substances can be used in combination. The term “to” indicating a numerical range represents “or more” and “or less”, and includes both the upper limit value and the lower limit value.

### Agent for Reducing Contamination in Frying Oil

In the present embodiment, the agent for reducing contamination in frying oil contains an ingredient (A), that is, a powdery granular material satisfying the following conditions (1) to (4).

Ingredient (A): a powdery granular material satisfying the following conditions (1) to (4);
(1) having a starch content of 75% by mass or more,
(2) containing 3% by mass or more and 45% by mass or less of a low-molecular-weight starch that is a starch having an amylose content of 5% by mass or more, in which a peak molecular weight of the low-molecular-weight starch is 3×10³ or more and 5×10⁴ or less,
(3) having a degree of swelling in cold water at 25° C. of 5 or more and 20 or less, and
(4) having a content of a fraction passing through a sieve with an opening of 1.4 mm and on a sieve with an opening of 0.15 mm of 5% by mass or more and 100% by mass or less.

As a result of studies to reduce contamination in frying oil (oil for deep-frying), generated during deep-frying of food, the present inventors have newly found that it is important to highly decrease migration of ingredients contained in the food before the frying to the frying oil. Among these, in a case where the food before the frying contains a spice, it is found that taste or aroma of the spice migrates to the frying oil, which is one of major factors of contaminants in the frying oil.

As a result of further studies to suppress the migration of the ingredients contained in the food before the frying, such as the spice, to the frying oil, it is newly found that the above-described ingredient (A) has an effect of reducing the contamination in the frying oil.

In the present embodiment, by using the agent for reducing contamination in frying oil containing the ingredient (A) as an active ingredient, the contamination in the frying oil can be suitably reduced.

In addition, in the present embodiment, by using the agent for reducing contamination in frying oil containing the ingredient (A) as an active ingredient, it is also possible to reduce, for example, the contamination in the frying oil when manufacturing a food containing a spice.

In addition, the agent for reducing contamination in frying oil is preferably an agent for reducing a migration of at least one of the aroma or the taste of the spice to the frying oil.

Hereinafter, the ingredient (A) will be specifically described.

### Ingredient (A)

The ingredient (A) is a powdery granular material containing starch as a main component, and satisfies the above-described conditions (1) to (4). The ingredient (A) may be, for example, a granulated product of raw material ingredients, and may be a product having a granulated size or a product adjusted to a predetermined size by pulverization or the like after the granulation.

With regard to the condition (1), from the viewpoint of reducing the contamination in the frying oil, the ingredient (A) contains 75% by mass or more of starch, preferably 80% by mass or more of starch and more preferably 85% by mass or more of starch.

In addition, the upper limit of the starch content in the ingredient (A) is not limited and is 100% by mass or less, and may be, for example, 99.5% by mass or less, or 99% by mass or less.

With regard to the condition (2), the ingredient (A) contains, as the above-described starch, a specific proportion of a low-molecular-weight starch made of a starch having an amylose content of 5% by mass or more as a raw material, and the low-molecular-weight starch used has a specific size. That is, the starch in the ingredient (A) contains 3% by mass or more and 45% by mass or less of a low-molecular-weight starch made of a starch having an amylose content of 5% by mass or more as a raw material in the ingredient (A), and a peak molecular weight of the low-molecular-weight starch is 3×10³ or more and 5×10⁴ or less.

From the viewpoint of reducing the contamination in the frying oil, the peak molecular weight of the low-molecular-weight starch is 3×10³ or more, preferably 8×10³ or more. In addition, from the same viewpoint, the peak molecular weight of the low-molecular-weight starch is 5×10⁴ or less, preferably 3×10⁴ or less and more preferably 1.5×10⁴ or less. A method of measuring the peak molecular weight of the low-molecular-weight starch will be described in the section of Examples.

From the viewpoint of excellent manufacturing stability of the low-molecular-weight starch, the low-molecular-weight starch is preferably one kind or two or more kinds selected from the group consisting of acid-treated starch, oxidized starch, and enzyme-treated starch, and more preferably acid-treated starch.

The conditions of the acid treatment for obtaining the acid-treated starch are not limited, and for example, the acid treatment can be performed as follows.

First, the starch having an amylose content of 5% by mass or more, which is the raw material of the low-molecular-weight starch, and water are put in a reactor, and then an acid is added thereto. Alternatively, acid water prepared by dissolving an inorganic acid in water and the starch as the raw material are put in a reactor. From the viewpoint of more stably performing the acid treatment, it is desirable that the entirety of the starch in the midst of reaction is uniformly dispersed in a water phase or is in a state of slurry. In order for the starch to be in such a state, a concentration of the starch slurry during the acid treatment is adjusted to be, for example, in a range of 10% by mass or more and 50% by mass or less, preferably in a range of 20% by mass or more and 40% by mass or less. In a case where the concentration of the slurry is too high, the slurry viscosity may increase, it may be difficult to stir the slurry uniformly.

Specific examples of the acid used for the acid treatment include an inorganic acid such as hydrochloric acid, sulfuric acid, and nitric acid, and the acid can be used regardless of the type, purity, and the like.

Regarding the conditions of the acid treatment reaction, from the viewpoint of stably obtaining the acid-treated starch, for example, a concentration of the inorganic acid during the acid treatment is preferably 0.05 normality (N) or more and 7 N or less, more preferably 0.1 N or more and 4 N or less, and still more preferably 0.2 N or more and 3 N or less. In addition, from the same viewpoint, a reaction temperature is preferably 30° C. or higher and 70° C. or lower, more preferably 35° C. or higher and 70° C. or lower, and still more preferably 35° C. or higher and 65° C. or lower. From the same viewpoint, a reaction time is preferably 0.5 hours or longer and 120 hours or shorter, more preferably 1 hour or longer and 72 hours or shorter, and still more preferably 1 hour or longer and 48 hours or shorter.

From the viewpoint of reducing the contamination in the frying oil, a content of the low-molecular-weight starch in the ingredient (A) is 3% by mass or more, preferably 8% by mass or more and more preferably 13% by mass or more.

In addition, from the same viewpoint, the content of the low-molecular-weight starch in the ingredient (A) is 45% by mass or less, preferably 35% by mass or less and more preferably 25% by mass or less.

In addition, from the viewpoint of reducing the contamination in the frying oil, the amylose content in the raw material starch of the low-molecular-weight starch is 5% by mass or more, preferably 12% by mass or more, more preferably 22% by mass or more, still more preferably 40% by mass or more, even more preferably 45% by mass or more, and even still more preferably 55% by mass or more. The upper limit of the amylose content in the raw material starch of the low-molecular-weight starch is not limited, and is 100% by mass or less, preferably 90% by mass or less.

As the starch having an amylose content of 5% by mass or more, which is the raw material of the low-molecular-weight starch, one kind or two or more kinds selected from the group consisting of high-amylose corn starch, corn starch, tapioca starch, sweet potato starch, potato starch, wheat starch, high-amylose wheat starch, rice starch, and processed starch chemically, physically, or enzymatically processed from these raw materials can be used. The starch having an amylose content of 5% by mass or more is preferably one kind or two or more kinds selected from the group consisting of high-amylose corn starch, corn starch, and tapioca starch, and more preferably high-amylose corn starch. As the high-amylose corn starch, for example, starch having an amylose content of 40% by mass or more is available. The starch having an amylose content of 5% by mass or more is more preferably a corn starch having an amylose content of 40% by mass or more.

In addition, the ingredient (A) satisfies the condition (3) for a degree of swelling in cold water. That is, from the viewpoint of reducing the contamination in the frying oil, the degree of swelling in cold water of the ingredient (A) at 25° C. is 5 or more, preferably 6 or more and more preferably 6.5 or more.

In addition, from the same viewpoint, the degree of swelling in cold water of the ingredient (A) at 25° C. is 20 or less, preferably 17 or less and more preferably 15 or less.

A method of measuring the degree of swelling in cold water of the ingredient (A) will be described in the section of Examples.

The ingredient (A) satisfies the condition (4) for size.

In the ingredient (A), from the viewpoint of reducing the contamination in the frying oil, with respect to the entire ingredient (A), a content of a fraction passing through a sieve with an opening of 1.4 mm and on a sieve with an opening of 0.15 mm is preferably 5% by mass or more, more preferably 8% by mass or more, still more preferably 12% by mass or more, even more preferably 50% by mass or more, and even still more preferably 70% by mass or more; and the upper limit thereof is 100% by mass or less, for example, 98% by mass or less, 95% by mass or less, or 90% by mass or less.

These sieves are specifically sieves in the JIS-Z8801-1 standard.

In the present embodiment, the ingredient (A) contains a starch other than the above-described low-molecular-weight starch. Various starch can be used as a starch component other than the low-molecular-weight starch in the ingredient (A). Specifically, the type thereof is not limited as long as the starch is starch which is generally commercially available depending on applications, for example, starch for foods; and one or more kinds can be appropriately selected from starches such as corn starch, potato starch, tapioca starch, and wheat starch, and processed starch chemically, physically, or enzymatically processed from these starches. The ingredient (A) preferably contains one kind or two or more kinds of starches selected from the group consisting of corn starch, wheat starch, potato starch, tapioca starch, and crosslinked starch of these starches.

In addition, the ingredient (A) may contain a component other than the starch. Specific examples of the component other than the starch include a colorant, an insoluble salt such as calcium carbonate and calcium sulfate, and an emulsifier.

From the viewpoint of further stabilizing an air bubble structure in the particles of the ingredient (A) and improving the manufacturing stability, it is preferable to blend the ingredient (A) with the insoluble salt. From the same viewpoint, a blending amount of the insoluble salt is preferably 0.1% by mass or more, and preferably 2% by mass or less.

Examples of the emulsifier include food emulsifiers.

Specific examples of the emulsifier include nonionic surfactants such as a sucrose fatty acid ester, monoglycerin fatty acid ester, polyglycerin fatty acid ester, polyglycerin condensed ricinoleic acid ester, propylene glycol fatty acid ester, acetic acid monoglyceride, lactic acid monoglyceride, citric acid monoglyceride, succinic acid monoglyceride, polysorbate, and sorbitan fatty acid ester; anionic surfactants such as diacetyl tartaric acid monoglyceride; and amphoteric surfactants such as lecithin.

From the viewpoint of reducing the contamination in the frying oil, the emulsifier is preferably a nonionic surfactant, and more preferably one or more kinds selected from sucrose fatty acid ester and monoglycerin fatty acid ester.

Examples of the sucrose fatty acid ester as one of the nonionic surfactants include an ester of sucrose and a fatty acid having 10 or more and 24 or less carbon atoms, and more specific examples thereof include sucrose stearic acid ester, sucrose palmitic acid ester, sucrose myristic acid ester, sucrose oleic acid ester, sucrose behenic acid ester, and sucrose erucic acid ester.

The number of carbon atoms in a fatty acid of the sucrose fatty acid ester is not limited, but is, for example, 10 or more, preferably 12 or more, more preferably 14 or more, and still more preferably 16 or more.

In addition, the number of carbon atoms in the fatty acid of the sucrose fatty acid ester is not limited, but is, for example, 24 or less, preferably 22 or less, more preferably 20 or less, and still more preferably 18 or less.

From the viewpoint of reducing the contamination in the frying oil, the fatty acid in the sucrose fatty acid ester is preferably a saturated fatty acid or a monounsaturated fatty acid, and more preferably a saturated fatty acid.

The sucrose fatty acid ester may include any of mono-, di-, tri-, or polyester of a fatty acid.

From the viewpoint of reducing the contamination in the frying oil, HLB of the sucrose fatty acid ester is preferably 0 or more, more preferably 0.5 or more, still more preferably 4 or more, and even more preferably 8 or more.

In addition, from the same viewpoint, the HLB of the sucrose fatty acid ester is preferably 18 or less and more preferably 17 or less.

Examples of the monoglycerin fatty acid ester include an ester of glycerin and a fatty acid having 6 or more and 24 or less carbon atoms, and more specific examples thereof include glycerin monocapric acid ester, glycerin monopalmitic acid ester, glycerin monostearic acid ester, and glycerin monobechenic acid ester.

From the viewpoint of reducing the contamination in the frying oil, the number of carbon atoms in a fatty acid of the monoglycerin fatty acid ester is, for example, 6 or more, preferably 10 or more and more preferably 14 or more.

In addition, from the same viewpoint, the number of carbon atoms in the fatty acid of the monoglycerin fatty acid ester is, for example, 24 or less, preferably 22 or less and more preferably 20 or less.

From the same viewpoint, the fatty acid in the monoglycerin fatty acid ester is preferably a saturated fatty acid or a monounsaturated fatty acid, and more preferably a saturated fatty acid.

From the same viewpoint, HLB of the monoglycerin fatty acid ester is preferably 0 or more and more preferably 1 or more.

In addition, from the viewpoint of reducing the contamination in the frying oil, the HLB of the monoglycerin fatty acid ester is preferably 16 or less, more preferably 9 or less, and still more preferably 6 or less.

From the viewpoint of reducing the contamination in the frying oil, a content of the emulsifier in the ingredient (A) is preferably 0.5% by mass or more, more preferably 0.6% by mass or more, and still more preferably 0.9% by mass or more with respect to the entire ingredient (A).

In addition, from the viewpoint of reducing the contamination in the frying oil, the content of the emulsifier in the ingredient (A) is preferably 0.5% by mass or more, more preferably 0.6% by mass or more, still more preferably 0.9% by mass or more, even more preferably 1.0% by mass or more, and even still more preferably 1.5% by mass or more with respect to the entire ingredient (A).

In addition, from the same viewpoint, the content of the emulsifier in the ingredient (A) is preferably 11% by mass or less, more preferably 9% by mass or less, and still more preferably 6% by mass or less with respect to the entire ingredient (A).

In addition, from the viewpoint of reducing the contamination in the frying oil, the content of the emulsifier in the ingredient (A) is preferably 11% by mass or less, more preferably 9% by mass or less, still more preferably 6% by mass or less, even more preferably 5% by mass or less, and even still more preferably 3% by mass or less with respect to the entire ingredient (A).

Next, a method of manufacturing the ingredient (A) will be described. The method of manufacturing the ingredient (A) includes, for example, the following steps.

(Preparing low-molecular-weight starch) a step of reducing molecular weight of a starch having an amylose content of 5% by mass or more to obtain a low-molecular-weight starch having a peak molecular weight of 3×10³ or more and 5×10⁴ or less

(Granulation) a step of heating and gelatinizing a raw material to granulate the raw material in which a content of low-molecular-weight starch is 3% by mass or more and 45% by mass or less and a total amount of the low-molecular-weight starch and a starch other than the low-molecular-weight starch is 75% by mass or more

The preparing the low-molecular-weight starch is a step of degrading a starch having an amylose content of 5% by mass or more to obtain the low-molecular-weight starch. The “degrading” means a degradation accompanied by a reduction of molecular weight of the starch, and typical examples of the degrading method include degradation by an acid treatment, an oxidation treatment, and an enzyme treatment. Among these, from the viewpoint of degradation rate, cost, and reproducibility of the degradation reaction, an acid treatment is preferable.

In addition, in the granulation, it is possible to use a general method used for granulating starch, and in view of obtaining a predetermined degree of swelling in cold water, it is preferable to use a general method used for heating and gelatinizing the starch. Specifically, methods using a machine such as a drum dryer, a jet cooker, an extruder, and a spray dryer are known, and in the present embodiment, from the viewpoint of more reliably obtaining the ingredient (A) having a degree of swelling in cold water which satisfies the specific conditions described above, heating and gelatinization by an extruder or a drum dryer is preferable, and an extruder is more preferable. In the case of extruder treatment, usually, water is added to the raw material including the starch such that the water content is adjusted to approximately 10% by mass or more and 60% by mass or less, and then the raw material is heated and gelatinized, for example, under the conditions of a barrel temperature of 30° C. or higher and 200° C. or lower, an outlet temperature of 80° C. or higher and 180° C. or lower, a screw rotation speed of 100 rpm or more and 1,000 rpm or less, and a heat treatment time of 5 seconds or longer and 60 seconds or shorter.

In the present embodiment, the granules obtained by heating and gelatinizing in the granulation can be pulverized, sieved, and adjusted in size as necessary. In addition, this may result in obtaining the ingredient (A) which satisfies the condition (4).

The obtained ingredient (A) may be used as the agent for reducing contamination in frying oil as it is, or it may be used in combination with other components as the agent for reducing contamination in frying oil. That is, the agent for reducing contamination in frying oil may be composed of the ingredient (A), or may contain a component other than the ingredient (A).

The agent for reducing contamination in frying oil may be, for example, in a form of a powder.

From the viewpoint of improving the effect of reducing the contamination in the frying oil, a content of the ingredient (A) in the agent for reducing contamination in frying oil is preferably 80% by mass or more, more preferably 90% by mass or more, still more preferably 95% by mass or more, and even more preferably 98% by mass or more with respect to the entire agent for reducing contamination in frying oil.

In addition, the content of the ingredient (A) in the agent for reducing contamination in frying oil is 100% by mass or less with respect to the entire agent for reducing contamination in frying oil. On the other hand, from the viewpoint of improving workability, the content of the ingredient (A) in the agent for reducing contamination in frying oil may be, for example, 10% by mass or less.

Examples of the component other than the ingredient (A), contained in the agent for reducing contamination in frying oil, include one kind or two or more kinds selected from the group consisting of cereal flour such as wheat flour, starch such as potato starch, polysaccharides, proteins, emulsifiers, and fats and oils.

Next, a method of using the agent for reducing contamination in frying oil will be described.

Specifically, the agent for reducing contamination in frying oil is applied to fried food (deep-fried food), preferably applied to fried foods before heat cooking, and more preferably applied to fried foods before deep-frying.

Specifically, the agent for reducing contamination in frying oil is applied to at least one of filling or coating material of the fried food, and preferably incorporated into the coating material of the fried food.

In addition, from the viewpoint of improving the effect of reducing the contamination in the frying oil in fried food containing a spice, the agent for reducing contamination in frying oil is preferably applied to at least one of filling or coating material of the fried food as a liquid containing the agent for reducing contamination in frying oil.

In a case where the agent for reducing contamination in frying oil is applied to the filling of the fried food, for example, the agent for reducing contamination in frying oil may be applied as it is, or as a processing liquid containing the agent for reducing contamination in frying oil. Examples of a method of applying the processing liquid to the filling include one or two or more methods selected from the group consisting of injection, tumbling, immersion, spraying, and coating.

In a case where the agent for reducing contamination in frying oil is applied to the coating material of the fried food, from the viewpoint of improving the effect of reducing the contamination in the frying oil in the fried food containing a spice, the agent for reducing contamination in frying oil is preferably blended in a batter liquid.

From the viewpoint of improving the effect of reducing the contamination in the frying oil, an amount of the agent for reducing contamination in frying oil in the fried food is preferably 0.05% by mass or more, more preferably 0.1% by mass or more, and still more preferably 0.5% by mass or more with respect to the entire fried food.

In addition, from the viewpoint of imparting a more preferred flavor, the amount of the agent for reducing contamination in frying oil in the fried food is preferably 10% by mass or less, more preferably 5% by mass or less, and still more preferably 2% by mass or less with respect to the entire fried food.

### Fried Food

The fried food is specifically obtained through a heating and cooking step using frying oil, and is typically various types of deep-fried foods.

Specific examples of the filling of the fried food include meat and vegetables.

Specific examples of the meat include meat of birds typified by domestic birds such as chicken, duck, turkey, goose, and duck; meat of a mammal such as cow, pig, sheep, and goat; and meat of fish and shellfish such as white-fleshed fish, shrimp, squid, and scallop.

Specific examples of the vegetables include potatoes, sweet potatoes, onions, carrots, burdocks, lotus roots, shiitake mushrooms, shishito pepper, eggplants, pumpkins, mushrooms, perilla leaves, and pickled ginger.

From the viewpoint of improving the effect of reducing the contamination in the frying oil, the fried food is preferably a food in which the batter liquid is used as the coating material, more preferably one kind selected from the group consisting of Karaage, fried chicken, Tatsutaage, Tempura, and nugget, and still more preferably fried chicken.

In addition, from the viewpoint of improving the effect of reducing the contamination in the frying oil, the fried food preferably contains a spice. From the same viewpoint, the agent for reducing contamination in frying oil is preferably applied to the fried food containing a spice.

Specific examples of the spice include one kind or two or more kinds selected from the group consisting of chili pepper, white pepper, paprika, Sichuan pepper, and pepper.

From the viewpoint of improving the effect of reducing the contamination in the frying oil, the spice preferably contains capsaicin. Examples of the spice containing capsaicin include chili peppers such as red chili pepper, green chili pepper, and cayenne pepper.

Specifically, the spice is contained in the filling or the coating material of the fried food. From the viewpoint of improving the effect of reducing the contamination in the frying oil, the spice is preferably contained in the coating material, and more preferably contained in the batter liquid. From the same viewpoint, it is also preferable that both the agent for reducing contamination in frying oil and the spice are contained in the batter liquid.

An amount of the spice in the fried food can be determined according to, for example, the type of the fried food. From the viewpoint of improving the aroma of the spice, the amount of the spice in the fried food is preferably 0.5% by mass or more, and more preferably 2% by mass or more with respect to the entire fried food.

In addition, from the viewpoint of imparting a more preferred flavor, the amount of the spice in the fried food is preferably 20% by mass or less, and more preferably 10% by mass or less with respect to the entire fried food.

In addition, from the viewpoint of imparting flavor, the content of the spice with respect to the content of the agent for reducing contamination in frying oil (spice/agent for reducing contamination in frying oil) in the fried food is preferably 1 time or more, more preferably 1.5 times or more, and still more preferably 2 times or more, in terms of mass ratio.

In addition, from the viewpoint of reducing the contamination in the frying oil, the above-described mass ratio (spice/agent for reducing contamination in frying oil) is preferably 10 times or less, more preferably 7 times or less, still more preferably 5 times or less, and even more preferably 3 times or less.

In addition, the fried food may contain aromatic vegetables such as garlic, ginger, and leek.

### Method for Reducing Contamination in Frying Oil

In the present embodiment, a method for reducing contamination in frying oil includes incorporating the ingredient (A) into a fried food.

From the viewpoint of improving the effect of reducing the contamination in the frying oil, the method for reducing contamination in frying oil preferably includes incorporating the ingredient (A) in a fried food before heat cooking, and more preferably includes incorporating the ingredient (A) in a fried food before deep-frying. More specifically, the method for reducing contamination in frying oil further includes deep-frying the fried food after the incorporating the ingredient (A).

The method for reducing contamination in frying oil is preferably a method for reducing the migration of at least one of the aroma or taste of the spice contained in the fried food to the frying oil.

In addition, in the method for reducing contamination in frying oil, the above-described configurations for the agent for reducing contamination in frying oil can be used.

The embodiments of the present invention have been described above, but these are examples of the present invention and various configurations other than the above can be adopted.

### EXAMPLES

Examples of the present invention will be shown below, but the gist of the present invention is not limited thereto.

### Raw Material

The following materials were mainly used as raw materials.

(Ingredient (A) and its raw material)

Corn starch: manufactured by J-OIL MILLS, INC., Corn starch Y

High-amylose corn starch: manufactured by J-OIL MILLS, INC., HS-7, amylose content: 70% by mass

Monoglycerin fatty acid ester: Poem P(V)S, constituent fatty acid C16 (60% with respect to all constituent fatty acids), C18 (40% with respect to all constituent fatty acids), HLB: 4.3, manufactured by RIKEN VITAMIN CO., LTD.

(A) Powdery granular material 1: powdery granular material obtained in Production Example 1

### Spice and Aromatic Vegetables

White pepper: manufactured by GABAN Co., Ltd.

Paprika powder: manufactured by S&B FOODS INC.

Red pepper: manufactured by S&B FOODS INC.

Garlic powder: manufactured by S&B FOODS INC.

Red pepper powder: manufactured by S&B FOODS INC.

Oleoresin capsicum: manufactured by Kalsec Inc.

### Other Raw Materials

Wheat flour: Flour, manufactured by Nisshin Flour Milling INC.

Corn starch: Waxy corn starch Y, manufactured by J-OIL MILLS, INC.

Expanding agent: F-UP, manufactured by AICOK Corporation

Thickener: Xanthan gum FJ, manufactured by Jungbunzlauer AG

Soybean protein: New Fujipro SHE, manufactured by Fuji Oil Co., Ltd.

Corn grits: manufactured by Pioneer Corporation

Corn flour: SOFT COAT AY, manufactured by J-OIL MILLS, INC.

Starch acetate (TC-200): HYTRUST TC-200, manufactured by J-OIL MILLS, INC.

Umami seasoning: “AJI-NO-MOTO”, manufactured by Ajinomoto Co., Inc.

Quality improver for meat: Meat Juicy Seasoning, manufactured by Ajinomoto Co., Inc.

Granule stock: manufactured by Ajinomoto Co., Inc.

Canola oil: AJINOMOTO SARASARA Canola Oil, manufactured by J-OIL MILLS, INC.

### Production Example of Powdery Granular Material

### Production Example 1: Powdery Granular Material 1

In the present example, a powdery granular material 1 was produced as a component A by the following procedure.

First, an acid-treated high amylose corn starch was prepared by the following procedure. That is, a high-amylose corn starch was suspended in water so as to prepare a 35.6% (w/w) slurry, and the slurry was heated to 50° C. While the slurry was stirred, a 4.25 N aqueous hydrochloric acid solution was added thereto at a mass ratio of 1/9 (HCl solution/slurry) to initiate a reaction. After the reaction for 16 hours, the reaction mixture was neutralized with 3% NaOH, rinsed with water, dehydrated, and dried, thereby obtaining the acid-treated high-amylose corn starch.

A peak molecular weight of the obtained acid-treated high-amylose corn starch was measured by the following method, it was 1.2×10⁴.

### Method of Measuring Peak Molecular Weight

The peak molecular weight was measured using an HPLC unit manufactured by TOSOH CORPORATION (Pump DP-8020, RI detector RS-8021, deaerator SD-8022).
(1) The sample was pulverized and collected as a fraction passing through a sieve with an opening of 0.15 mm, which was a sieve in the JIS-Z8801-1 standard; The collected fraction was suspended in a mobile phase at 1 mg/mL, and the suspension was heated at 100° C. for 3 minutes such that the fraction completely dissolved; the suspension was filtered through a 0.45 μm filter (manufactured by ADVANTEC Group, DISMIC-25HP PTFE 0.45 μm), and the filtrate was used as an analysis sample.
(2) A molecular weight was measured under the following analytical conditions.

column: two columns of TSKgel α-M (7.8 mmφ, 30 cm) (manufactured by TOSOH CORPORATION)

flow rate: 0.5 mL/min

mobile phase: 5 mM NaNO₃-containing 90% (v/v) dimethyl sulfoxide solution

column temperature: 40° C.

analysis amount: 0.2 mL
(3) The detector data was collected by software (multi-station GPC-8020 model II data collection ver 5.70, manufactured by TOSOH CORPORATION), and the molecular weight peak was calculated.

Pullulan (Shodex Standard P-82, manufactured by SHOWA DENKO K.K.) with a known molecular weight was used for the calibration curve.

Next, a powdery granular material was produced using the obtained acid-treated high-amylose corn starch. That is, 77 parts by mass of corn starch, 20 parts by mass of the acid-treated high-amylose corn starch, 1 part by mass of calcium carbonate, and 2 parts by mass of monoglycerin fatty acid ester were mixed together in a bag until sufficiently uniform to obtain a mixture. The above-described mixture was treated by pressing and heating with a twin screw extruder (KEI-45, manufactured by KOWA KOGYO Inc.). The treatment conditions were as follows.

Supply of raw material: 275 g/min (heat treatment time: approximately 60 seconds)

Addition of water: water was added such that the water amount was 24% by mass with respect to the entire mixture

Barrel temperature: 50° C., 70° C., 100° C., and 130° C. to the outlet from the raw material inlet

Outlet temperature: 130° C. to 150° C.

Rotation speed of screw: 230 rpm

The heated and gelatinized substance obtained as above by the extruder treatment was dried at 110° C. such that the water content was adjusted to approximately 10% by mass.

Next, the dried heated and gelatinized substance was pulverized with a table-top cutter pulverizer, and then classified through sieves according to the JIS-Z8801-1 standard to obtain a powdery granular material 1 in which each fraction was mixed to the particle size distribution shown in Table 1. The obtained powdery granular material 1 had the following particle size distribution.

undersize of 3.35 mm sieve and oversize of 1.4 mm sieve: 0%

undersize of 1.4 mm sieve and oversize of 1 mm sieve: 13%

undersize of 1 mm sieve and oversize of 0.5 mm sieve: 39%

undersize of 0.5 mm sieve and oversize of 0.25 mm sieve: 20%

undersize of 0.25 mm sieve and oversize of 0.15 mm sieve: 10%

undersize of 0.15 mm sieve and oversize of 0.075 mm sieve: 14%

undersize of 0.075 mm sieve and oversize of 0.038 mm sieve: 3%

undersize of 0.038 mm sieve: 1%

In addition, a degree of swelling in cold water of the powdery granular material 1 was 8.9. The degree of swelling in cold water was measured by the following method.

### Method of Measuring Degree of Swelling in Cold Water

1. 1 g of the sample (A) was weighed and placed in a 50 mL Falcon tube.
2. While stirring with a vortex mixer, water was added to the tube up to the 50 mL mark.
3. The tube was inverted 5 times for mixing so that the precipitate was dispersed, the precipitate was stirred with the vortex mixer for 10 seconds, and the tube was left to stand at room temperature for 30 minutes.
4. The tube was subjected to centrifugation at 4,000 rpm for 30 minutes so that the sample was divided into a precipitate layer and a supernatant layer,

(centrifuge: Hitachi table-top centrifuge CT6E manufactured by Koki Holdings Japan Co., Ltd.; rotor: T4SS swing rotor; adapter: 50TC×2S adapter).
5. The supernatant was removed with a pipette, and the mass of the sediment layer was measured and defined as B (g).
6. The mass of the precipitate layer was measured after drying and solidifying the precipitate layer (105° C., 24 hours), and defined as C (g).
7. B/C was defined as the degree of swelling in cold water of the powdery granular material.

### Examples 1 and 2, and Comparative Example 1

In the present example, fried chicken was produced, and contamination in oil due to deep-frying was evaluated. In Examples 1 and 2, the powdery granular material 1 was used as an agent for reducing contamination in frying oil. In Examples 1 and 2, the agent for reducing contamination in frying oil was blended into a pickling liquid and a batter liquid, respectively. In Comparative Example 1, the powdery granular material 1 was not blended.

### Method of Producing Fried Chicken

### Formulation of Pickling Liquid and Coating Material

The formulation of the pickling liquid, the batter liquid, and the breader is shown below.

### Formulation of Pickling Liquid

A pickling liquid having the following composition was prepared. In Example 1, in addition to the following components, 3 parts by mass of the powdery granular material 1 were blended.

| Component | Part by mass |
|---|---|
| Starch acetate (TC-200) | 6.00 |
| Refined sugar | 4.00 |
| Salt | 4.00 |
| Glutamate Na | 2.00 |
| Red pepper powder | 5.00 |
| White pepper | 1.00 |
| Garlic powder | 2.00 |
| Oleoresin capsicum | 1.00 |
| Quality improver for meat | 1.00 |
| Granule stock | 1.00 |
| Xanthan gum | 0.20 |
| Soy sauce | 3.00 |
| Ice water | 70.00 |
| Total | 100.20 |

### Formulation of Batter Liquid

A batter liquid having the following composition was prepared. In Example 2, in addition to the following components, 3 parts by mass of the powdery granular material 1 were blended.

| Component | Part by mass |
|---|---|
| Wheat flour | 90.0 |
| Corn starch | 10.0 |
| Table salt | 0.5 |
| Expanding agent | 1.0 |
| Thickener | 0.2 |
| Subtotal: | 101.7 |

Water: 160 parts by mass relative to the above sub-total

### Formulation of Breader

A breader having the following composition was prepared.

| Component | Part by mass |
|---|---|
| Wheat flour | 85.0 |
| Soybean protein | 3.0 |
| Corn grits | 2.5 |
| Corn flour | 2.5 |
| Umami seasoning | 1.5 |
| White pepper | 0.3 |
| Paprika powder | 3.7 |
| Red pepper | 1.0 |
| Garlic powder | 0.2 |
| Table salt | 0.5 |
| Expanding agent | 0.3 |
| Total | 100.5 |

### Manufacturing Procedure

1. The chicken breast meat was cut into pieces weighing 80 to 100 grams each.
2. 3 kg of the cut chicken breast meat and 0.6 kg of the pickle liquid were put into a cooling tumbler (VAKONO, manufactured by ONO SHOJI CORP.), and tumbled for 1 hour at a motor output of 50% and a vacuum of 60%.
3. A 17% by mass of batter liquid was added to the chicken breast meat after the tumbling, and mixed.
4. An appropriate amount of a breader was added to the chicken breast meat coated with the batter liquid, and mixed.
5. The chicken breast meat coated with the breader was deep-fried in canola oil at 170° C. for 5 minutes; the deep-frying was carried out using different frying oils for each of Examples.

### Evaluation of Contamination in Frying Oil

### Sensory Evaluation

After the frying oil of each of Examples was allowed to cool following the deep-frying, one panelist evaluated the spiciness thereof. The evaluation criteria are described below.
5: No spiciness was felt at all
4: slightly spicy
3: moderately spicy
2: spicy
1: very spicy

TABLE 1

| | Comparative | | |
|---|---|---|---|
| | Example 1 | Example 1 | Example 2 |
| Addition of powdery | None | Pickling | Batter |
| granular material | | liquid | liquid |
| Spiciness of frying oil | 3.0 | 3.5 | 4.0 |

### Quantification of Capsaicin in Frying Oil

1. The frying oil of each of Examples, after the deep-frying residue was removed, was supplied as a sample for LCMS.
2. 10 μg of the sample was weighed, 10 mL of acetone was added, the mixture was well mixed, passed through a 0.45 μm filter (manufactured by Advantec Co., Ltd.), and dispensed into a 1.5 mL vial.
3. The LCMS measurement was performed under the following conditions, and the amount of capsaicin was measured.

HPLC device: UltiMate 3000 (manufactured by Thermo Fisher Scientific Inc.)

MS device: ISQ EM (manufactured by Thermo Fisher Scientific Inc.)

Column: Shimadzu ODS VP-ODS (250 L×4.6)

Gradient conditions of the mobile phase: the initial condition started from 50% of the A liquid; after 0 to 8 minutes, the mixing proportion of the A liquid was changed linearly from 50% to 0%; and after 8 minutes to 13 minutes, 0% of the A liquid was maintained.

A liquid: methanol:ultrapure water:formic acid=30:70:0.1

B liquid: isopropanol:formic acid=100:0.1

Injection amount: 10 μL

Flow rate: 0.5 mL/min

Calibration curve sample: capsaicin (manufactured by FUJIFILM Wako Pure Chemical Corporation) was dissolved in canola oil at concentrations of 100, 10, and 1 ppm; the other samples were measured in the same manner as in 1. described above.

In each of Examples, the amount (mg) of capsaicin blended in the fried food, the amount (mg) of capsaicin in the frying oil after frying, and the outflow proportion (%) are shown in Table 2.

In Table 2, the amount of capsaicin was calculated on the assumption that the amount of capsaicin per 1 g of chili pepper was 1 mg.

TABLE 2

| | Amount of capsaicin | Amount of capsaicin | |
|---|---|---|---|
| | blended in fried | in oil after | Outflow |
| | food (mg) | frying (mg) | proportion |
| Comparative | 155.0 | 35.6 | 23.0% |
| Example 1 | | | |
| Example 1 | 155.0 | 26.1 | 16.9% |
| Example 2 | 155.0 | 20.6 | 13.3% |

From Table 2, in each of Examples in which the agent for reducing contamination in frying oil consisting of the powdery granular material 1 was blended into the pickling liquid or the batter liquid, the outflow of the capsaicin to the frying oil could be reduced as compared with Comparative Example. In addition, from Table 1, in each of Examples, the pungent flavor of the frying oil after the deep-frying was also reduced.

Priority is claimed on Japanese Patent Application No. 2022-088469, filed on May 31, 2022, the disclosure of which is incorporated herein by reference.

1. An agent for reducing contamination in frying oil comprising the following ingredient (A),
the ingredient (A): a powdery granular material satisfying the following conditions (1) to (4),
(1) having a starch content of 75% by mass or more,
(2) containing 3% by mass or more and 45% by mass or less of a low-molecular-weight starch that is a starch having an amylose content of 5% by mass or more, in which a peak molecular weight of the low-molecular-weight starch is 3×10³ or more and 5×10⁴ or less,
(3) having a degree of swelling in cold water at 25° C. of 5 or more and 20 or less, and
(4) having a content of a fraction passing through a sieve with an opening of 1.4 mm and on a sieve with an opening of 0.15 mm of 5% by mass or more and 100% by mass or less.

2. The agent for reducing contamination in frying oil according to claim 1, being applied to a fried food containing a spice.

3. The agent for reducing contamination in frying oil according to claim 2, wherein the spice contains capsaicin.

4. The agent for reducing contamination in frying oil according to claim 2,
wherein the fried food is one kind selected from the group consisting of Karaage, fried chicken, Tatsutaage, Tempura, and nugget.

5. The agent for reducing contamination in frying oil according to claim 2, being blended in a coating material of the fried food.

6. The agent for reducing contamination in frying oil according to claim 5,
wherein the coating material is a batter liquid.

7. A method for reducing contamination in frying oil, comprising:
incorporating the following ingredient (A) into a fried food,
the ingredient (A): a powdery granular material satisfying the following conditions (1) to (4),
(1) having a starch content of 75% by mass or more,
(2) containing 3% by mass or more and 45% by mass or less of a low-molecular-weight starch that is a starch having an amylose content of 5% by mass or more, in which a peak molecular weight of the low-molecular-weight starch is 3×10³ or more and 5×10⁴ or less,
(3) having a degree of swelling in cold water at 25° C. of 5 or more and 20 or less, and
(4) having a content of a fraction passing through a sieve with an opening of 1.4 mm and on a sieve with an opening of 0.15 mm of 5% by mass or more and 100% by mass or less.

8. The method for reducing contamination in frying oil according to claim 7,
wherein the fried food contains a spice.

9. The method for reducing contamination in frying oil according to claim 8,
wherein the spice contains capsaicin.

10. The method for reducing contamination in frying oil according to claim 7,
wherein the fried food is one kind selected from the group consisting of Karaage, fried chicken, Tatsutaage, Tempura, and nugget.

11. The method for reducing contamination in frying oil according to claim 7,
wherein the ingredient (A) is blended in a coating material of the fried food.

12. The method for reducing contamination in frying oil according to claim 11,
wherein the coating material is a batter liquid.
